(19) United States
(12) Patent Application Publication
(10) Pub. No.: US 2009/0147373 A1
(43) Pub. Date: Jun. 11, 2009

(54) Dynamic Focus Optical Probes

(75) Inventors: Jannick Rolland, Chuluota, FL (US); Panomsak Meemon, Orlando, FL (US); Kye-Sung Lee, Orlando, FL (US); Supraja Murali, Oviedo, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNIVERSITY OF CENTRAL FLORIDA RESEARCH FOUNDATION, INC., Orlando, FL (US)

(21) Appl. No.: 12/252,511

(22) Filed: Oct. 16, 2008

Related U.S. Application Data
(60) Provisional application No. 60/981,396, filed on Oct. 19, 2007.
(60) Provisional application No. 60/981,545, filed on Oct. 22, 2007.

(51) Int. Cl. G02B 3/12

(52) U.S. Cl. 359/665

(57) ABSTRACT

In one embodiment, an optical probe includes a housing, and an optical system provided within the housing, the optical system having a dynamically adjustable focal length such that the optical system can be focused at different points spaced a variety of distances from the housing while the probe is in use.

### CROSS-REFERENCE TO RELATED APPLICATION

This application claims priority to copending U.S. provisional applications entitled, “Dynamic Focus Catheter Design for Endoscopic OCT and OCM,” having Ser. No. 60/981,396, filed Oct. 19, 2007, and “Dynamic Focus Catheter Design for Endoscopic OCT,” having Ser. No. 60/981,545, filed Oct. 22, 2007, both of which are entirely incorporated herein by reference.

### BACKGROUND

There are various uses for optical probes that can be passed into a vessel and capture images of the vessel walls. One such use pertains to imaging the internal structures of the walls of an artery to identify plaques that are vulnerable to rupture that could cause a myocardial infarction.

One challenge to developing such an optical probe relates to capturing images across a relatively large depth of focus at relatively high lateral resolution. Specifically, because depth of focus is inversely proportional to lateral resolution, the designer of the probe's optical system can be left with a choice between relatively large depth of focus at the expense of lateral resolution or relatively high lateral resolution at the expense of depth of focus.

It can therefore be appreciated that it would be desirable to have an optical probe comprising an optical system that enables images to be captured over a relatively large depth of focus at relatively high lateral resolution.

### BRIEF DESCRIPTION OF THE FIGURES

The components in the drawings are not necessarily to scale, emphasis instead being placed upon clearly illustrating the principles of the present disclosure. In the drawings, like reference numerals designate corresponding parts throughout the several views.

FIG. 1 is a perspective view of a first embodiment of an optical probe.

FIG. 2 is a side view of the optical probe of FIG. 1, illustrating internal components of the probe.

FIGS. 3A and 3B are schematic side views of an embodiment of a variable focus lens that can be used in an optical probe.

FIG. 4 is a partial side view of a second embodiment of an optical probe.

FIG. 5 is a partial side view of a third embodiment of an optical probe.

FIG. 6 is a partial side view of a fourth embodiment of an optical probe.

FIG. 7A is a schematic perspective view illustrating combination of a first cylindrical lens and a view window of the optical probe of FIG. 6.

FIG. 7B is a schematic perspective view illustrating combination of a second cylindrical lens and a view window of the optical probe of FIG. 6.

FIGS. 8A-8C are schematic views of the optical system of the probe of FIG. 6 in different focusing configurations.

FIGS. 9A-9C are modulation transfer functions (MTFs) for the focusing configurations shown in FIGS. 8A-8C.

FIGS. 10A and 10B are depictions of embodiments of use of an optical probe within a vessel or lumen.

FIG. 11 is a block diagram of an embodiment of a system for performing endoscopic optical coherence tomography (OCT).

### DETAILED DESCRIPTION

As described above, it would be desirable to have an optical probe comprising an optical system that enables images to be captured over a relatively large depth of focus at relatively high lateral resolution. Examples of such optical probes are described in the following disclosure. In some embodiments, an optical probe comprises an optical system whose focal length can be dynamically adjusted. With such an optical system, high resolution images can be captured at a variety of distances from the probe. In some embodiments, the dynamic focusing is provided by a variable focus lens having no moving mechanical components.

In the following, described are various embodiments of optical probes. Although particular embodiments of optical probes and the optical systems they comprise are described, those embodiments are mere example implementations of the disclosed probes and optical systems. Furthermore, the terminology used in this disclosure is selected for the purpose of describing the disclosed probes and optical systems and is not intended to limit the breadth of the disclosure.

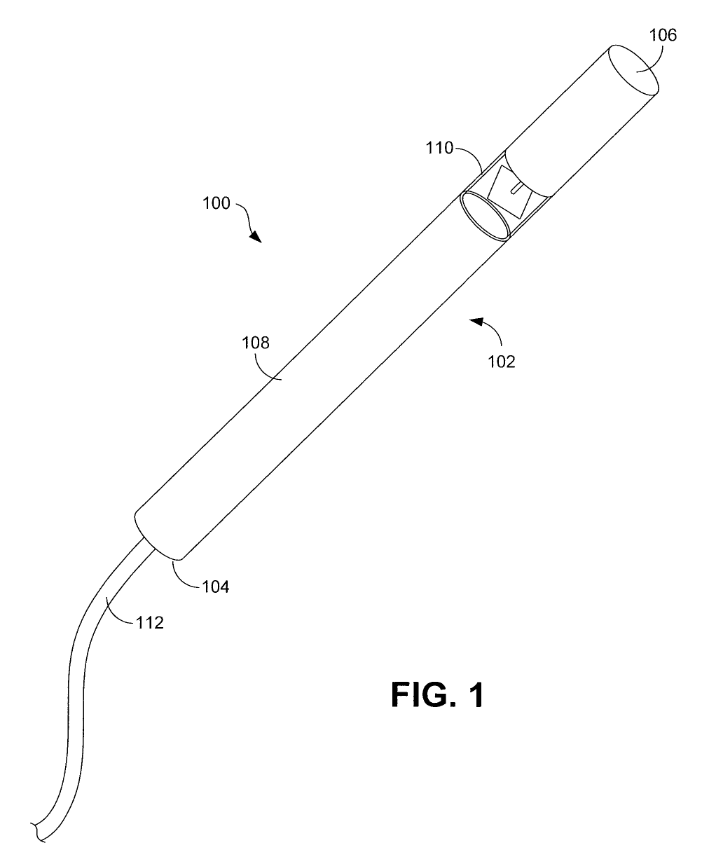

Beginning with FIG. 1, illustrated is an embodiment of an optical probe 100 that is suitable for use within narrow vessels or lumens, such as arteries, lung lobes, and other biological structures. Although biological structures have been specifically identified as possible applications for the probe 100, it is to be understood that the probe also can be used within non-biological vessels or lumens.

As shown in FIG. 1, the probe 100 includes a generally cylindrical outer housing 102. The outer housing 102 is elongated and comprises a proximal end 104, a distal end 106, and an outer periphery 108 that extends between the two ends. In the illustrated embodiment, an imaging window 110 is provided along the outer periphery 108 adjacent the distal end 106 of the probe 100. Visible through the imaging window 110 in FIG. 1 are components of an internal optical system of the probe, example embodiments of which being described below. In the example of FIG. 1, the imaging window 110 spans the circumference of the outer housing 102 so as to permit 360° viewing using the internal optical system.

The optical probe 100 is dimensioned such that it may be used in narrow, for example small diameter, vessels or lumens. By way of example, the optical probe 100 has an outer diameter of approximately 1 millimeters (mm) to 5 mm, and a length of approximately 3 mm to 12 mm from its proximal end 104 to its distal end 106.

Extending from the proximal end 104 of the optical probe 100 is a flexible cord 112 that, as described below, transmits light to and receives optical signals from the probe. The outer diameter of the cord 112 can be smaller than that of the probe 100, and the length of the cord can depend upon the particular application in which the probe is used. Generally speaking, however, the cord 112 is long enough to extend the probe 100 to a site to be imaged while the cord is still connected to a light source (not shown) that transmits light through the cord to the probe.

The materials used to construct the optical probe 100 and its cord 112 can be varied to suit the particular application in which they are used. In biological applications, biocompatible materials are used to construct the probe 100 and cord 112. For example, the outer housing 102 of the probe 100 can be made of stainless steel or a biocompatible polymeric material. The imaging window 110 can be made of a suitable transparent material, such as glass, sapphire, or a clear, biocompatible polymeric material. In some embodiments, the material used to form the imaging window 110 can also be used to form a portion or the entirety of outer housing 102.

The cord 112 can comprise a lumen made of a resilient and/or flexible material, such as a biocompatible polymeric material. In some embodiments, the cord 112 can comprise a lumen composed of an inner metallic coil or braid, for example formed of stainless steel or nitinol, which is surrounded by an impermeable polymeric sheath. Such an arrangement provides additional column strength and kink resistance to the cord 112 to facilitate advancing of the probe 100 to the imaging site. In addition, the outer housing 102 and/or the cord 112 can be coated with a lubricious coating to facilitate insertion and withdrawal of the probe to and from the imaging site.

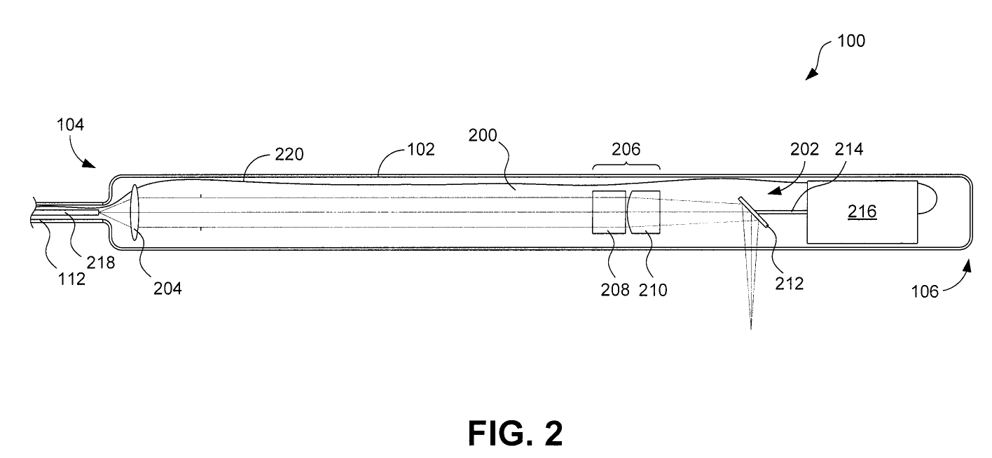

FIG. 2 illustrates the interior 200 of the optical probe 100 and cord 112. As is shown in that figure, the probe 100 houses an internal optical system 202. In the embodiment of FIG. 2, the optical system 202 comprises collimation optics including a collimating lens 204, a focusing system 206 including a first focusing lens 208 and a second focusing lens 210, and a fold mirror 212. Each of the collimating lens 204, first focusing lens 208, and second focusing lens 210 are fixedly mounted within the housing 102 using appropriate mounting fixtures (not shown). Substantially any mounting fixtures that secure the lenses in place and that do not undesirably obstruct the transmission of light through the optical system 202 can be used.

In some embodiments, the first focusing lens 208 comprises a variable focus lens having no moving mechanical components. In such a case, the focal length of the optical system 202 can be dynamically adjusted to change the point at which the optical system focuses. Therefore, as described below, the optical system 202 can be used to capture images across a relatively large depth of focus (i.e., working range), for example within a wall of a vessel to be imaged. As used herein, the term “depth of focus” pertains to a range (i.e., working range) of focus points along a depth direction, as opposed to a discrete focus point at a given depth. In some embodiments, the second focusing lens 210 comprises a singlet lens, a doublet lens, a triplet lens, a grin lens, or combinations thereof.

The fold mirror 212 is mounted to a shaft 214 of a micromotor 216 that is fixedly mounted adjacent the distal end 106 of the probe 100. Therefore, the mirror can rotate with the shaft 214 under the driving force of the micromotor 216.

Extending through the cord 112 is an optical wave guide 218, such as a single-mode optical fiber, and a power cord 220 that also extends through the optical probe 100 to the micromotor 216 to provide power to the micromotor. By way of example, the micromotor comprises a 1.9 mm Series 0206 micromotor produced by MicroMo Electronics, Inc.

With the above-described configuration, light from a high-intensity light source (not shown) can be transmitted by the optical wave guide 218 to the collimating lens 204, to the focusing system 206, to the mirror 212, and then radially outward from the optical probe 100 to the imaging site (not shown). When the micromotor 216 is activated, it rotates the shaft 214 and, therefore, axially rotates the mirror 212 about the longitudinal central axis (i.e., the central axis extending between the proximal and distal ends) of the probe 100 such that images can be captured substantially through 360°, if desired.

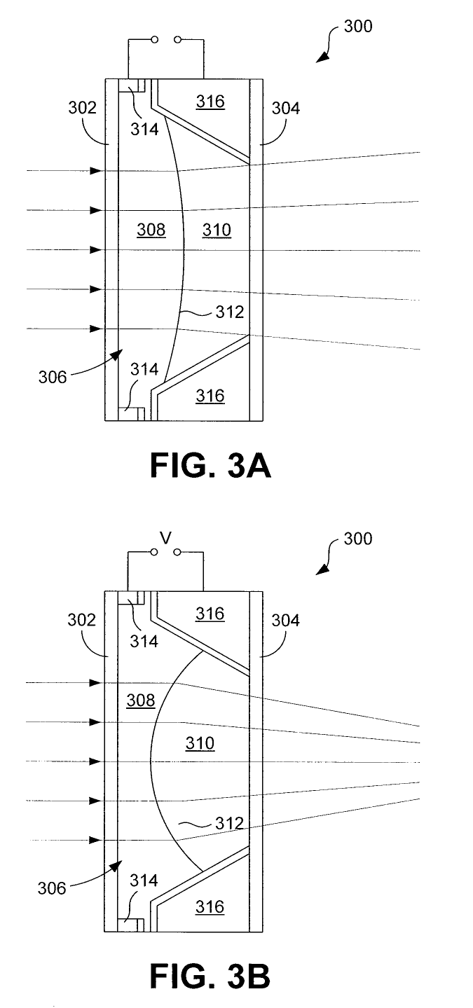

FIGS. 3A and 3B illustrate an example variable focus lens 300 that can be used in an optical probe, such as the probe 100. More particularly, illustrated in FIGS. 3A and 3B is an example liquid lens. As indicated in those figures, the lens 300 comprises first and second windows 302 and 304 that define an interior space 306. Provided within the interior space is a first liquid 308 and a second liquid 310 that have different refractive indices. In some embodiments, the first liquid 308 is an electrically conductive liquid, such as water, and the second liquid 310 is an electrically non-conductive liquid, such as oil. Because the liquids 308 and 310 are immiscible relative to each other, a meniscus 312 forms between the liquids at their interface that acts as a lens surface. The shape of the meniscus 312 can be controlled through application of an appropriate voltage across conductive electrodes 314 and 316. In FIG. 3A, no voltage is applied across the electrodes 314, 316, and the meniscus 312 assumes a first shape (i.e., orientation, and radius of curvature). In FIG. 3B, however, a voltage, V, is applied across the electrodes 314, 316, and the meniscus 312 assumes a second shape (i.e., orientation and radius of curvature). As can be appreciated through comparison of FIGS. 3A and 3B, the change in shape in the meniscus 312 controls the transmission of light rays through the lens 300. Specifically, in the illustrated embodiment, application of a voltage to the lens 300 focuses the light rays nearer to the lens 300.

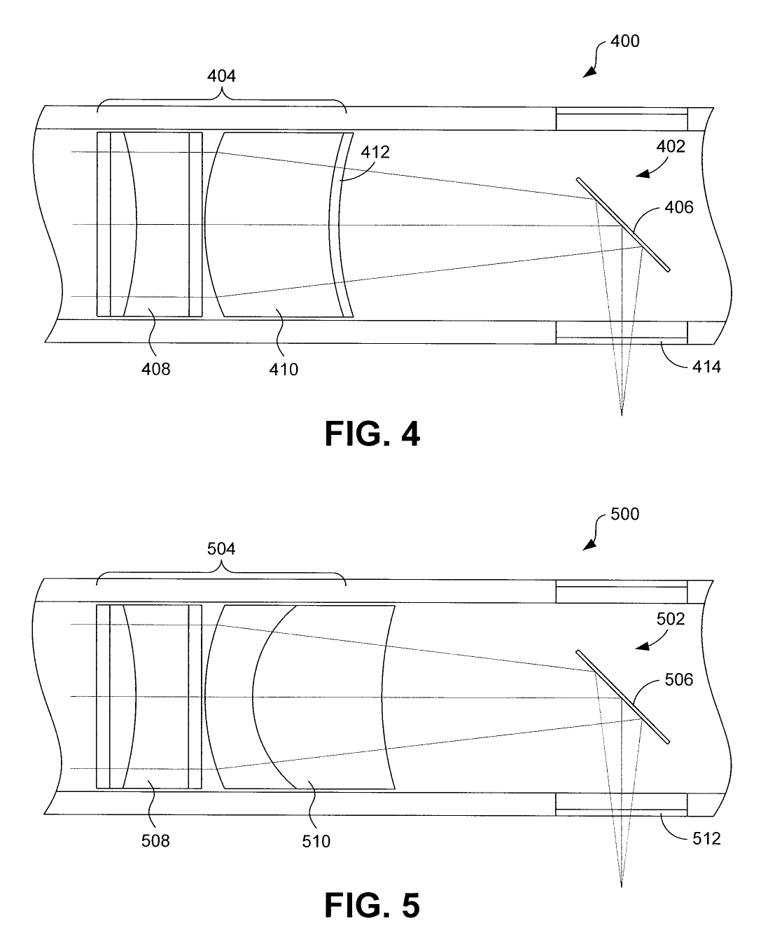

FIG. 4 illustrates a portion of a second optical probe 400. The optical probe 400 comprises an optical system 402 that includes a focusing system 404 and a fold mirror 406. The focusing system 404 comprises a variable focus lens 408, such as a liquid lens or a liquid crystal lens. By way of example, the variable focus lens 408 can comprise a liquid lens by Varioptics, Inc. or Philips Corporation.

In addition to the variable focus lens 408, the focusing system 404 comprises a singlet lens 410 that is used to shorten the focal length of the optical system 402 so that objects nearer the probe 400 can be imaged. In some embodiments, the singlet lens 410 comprises a diffractive optical element 412 that corrects chromatic aberrations. When provided, the diffractive optical element 412 can be provided on either surface of the singlet lens 410. In the embodiment of FIG. 4, the diffractive optical element 412 is provided on the convex surface of the singlet lens 410. Although the diffractive optical element 412 is shown provided on the singlet lens 410, the diffractive optical element could alternatively be provided elsewhere in the optical system 402, if desired.

As is further indicated in FIG. 4, the variable focus lens 408 and the singlet lens 406 together focus light on the fold mirror 406, which reflects the light out from the probe 400 through a view window 414.

FIG. 5 illustrates a portion of a third optical probe 500. The optical probe 500 is similar to the probe 400 and therefore comprises an optical system 502 that includes a focusing system 504 and a fold mirror 506. The focusing system 504 of the probe 500 comprises a variable focus lens 508 similar to that described above. Instead of a singlet lens, however, the focusing system 504 includes a doublet lens 510 that both shortens the optical system focal length and compensates for chromatic aberration. The doublet lens 510 can comprise two separate lenses that are independent of or coupled (e.g., cemented) to each other. The probe 500 also comprises a view window 512.

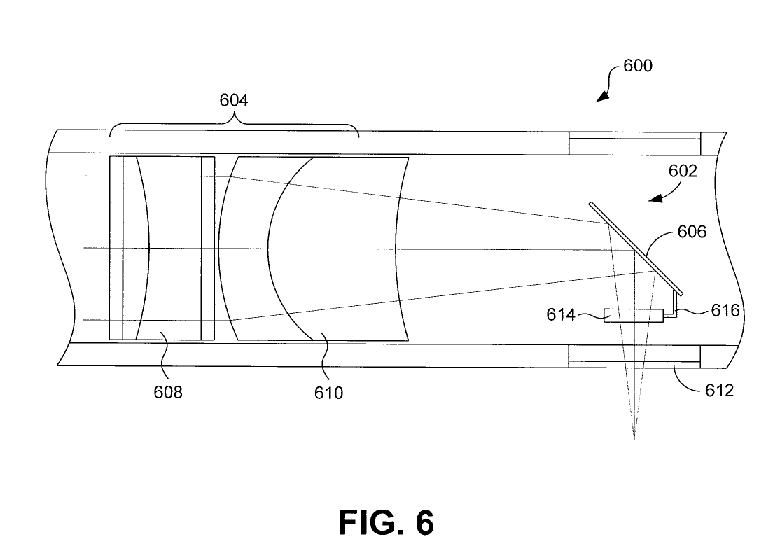

FIG. 6 illustrates a portion of a third optical probe 600. The optical probe 600 is similar to the probe 500 and therefore comprises an optical system 602 that includes a focusing system 604 and a fold mirror 606 that reflects rays out from a view window 612. Like the focusing system 504, the focusing system 604 of the probe 600 comprises a variable focus lens 608 and a doublet lens 610. In addition, however, the probe 600 further includes an imaging lens 614 that is mounted to the fold mirror 606 with a mounting member 616 such that the imaging lens rotates with the mirror when the mirror is driven by a micromotor (not shown). In alternative embodiments, the imaging lens 614 can be directly mounted to the micromotor shaft (not shown). Irrespective of the mounting arrangement used, the imaging lens 614 is used to correct astigmatism introduced by the view window 612.

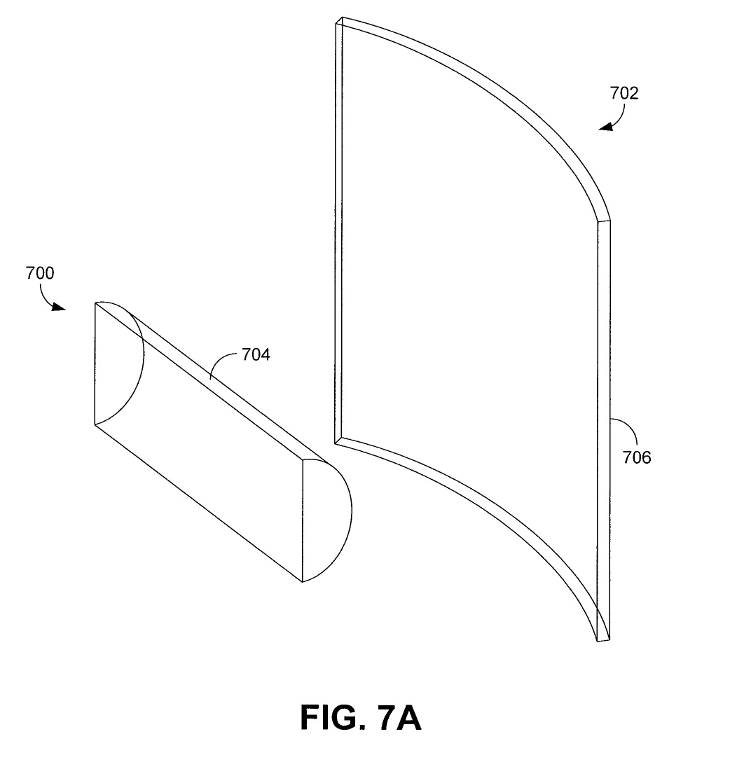

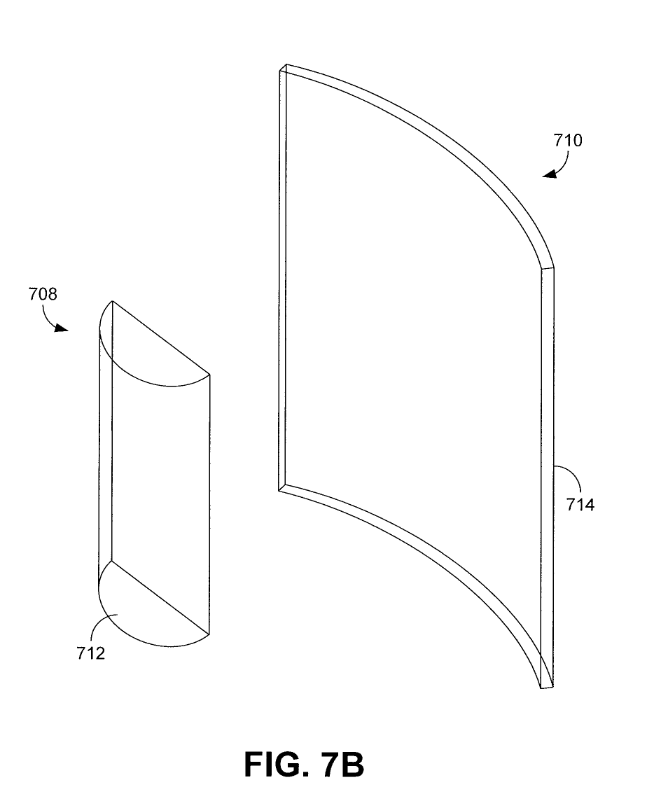

In some embodiments, the imaging lens 614 comprises a cylindrical lens that complements the curvature of the view window 612. FIG. 7A schematically illustrates the relationship between a first cylindrical lens 700 and a view window 702 (only a portion of the view window shown in FIG. 7A). As indicated in FIG. 7A, the cylindrical lens 700 has a curved surface 704 whose curvature is perpendicular to the radius of curvature of the curved surface 706 of the view window 702. When such a cylindrical lens 700 is used, the astigmatic optical aberration caused by the view window 612 is partially or completely canceled.

FIG. 7B schematically illustrates the relationship between a second cylindrical lens 708 and a view window 710 (only a portion of the view window shown in FIG. 7B). As indicated in FIG. 7B, the cylindrical lens 708 has a curved surface 712 whose curvature is parallel, but opposite, to the radius of curvature of the curved surface 714 of the view window 710, thereby also achieving optical aberration cancellation.

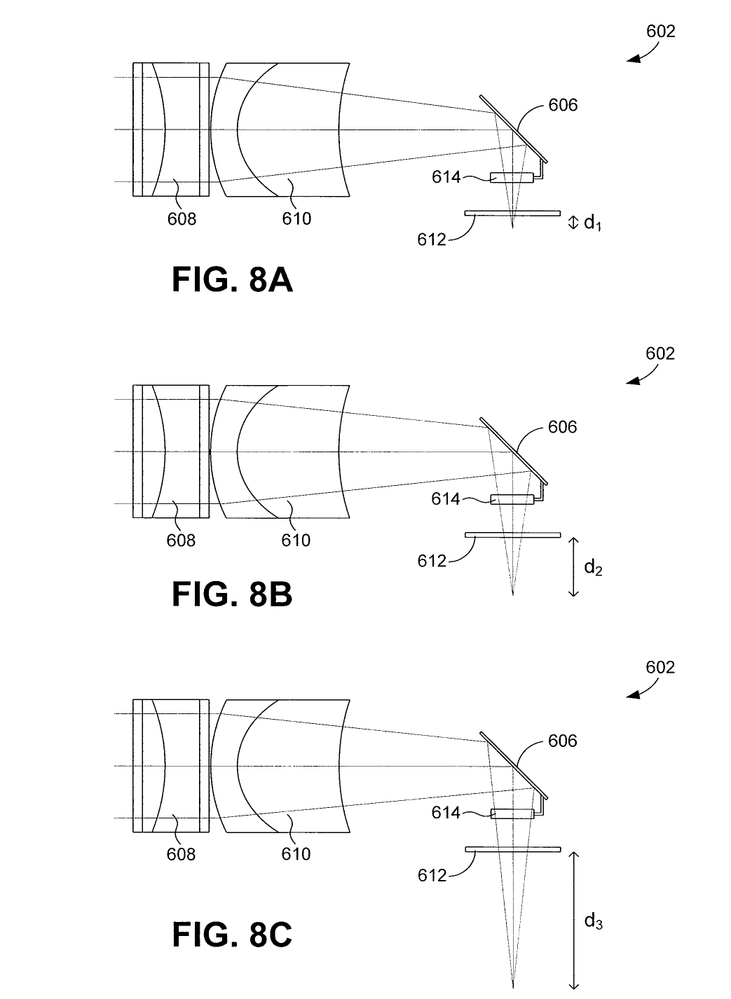

As described above, the disclosed optical probes can be used to capture high resolution images across a large depth of focus or working range. FIGS. 8A-8C illustrate the optical system 602 of the optical probe 600 in three different focusing configurations. More particularly, FIGS. 8A-8C illustrate three different focal depths achieved through adjustment of the variable focus lens 608. In FIG. 8A, the variable focus lens 608 is controlled to shorten the focal length of the optical system 602. By way of example, the optical system 602 is focused at a point approximately 0.5 mm from the outer surface of the view window 612 (distance, d₁, in FIG. 8A). In FIG. 8B, the variable focus lens 608 is controlled to lengthen the focal length of the optical system 602 relative to that shown in FIG. 8A. By way of example, the optical system 602 is focused at a point approximately 2.4 mm from the outer surface of the view window 612 (distance, d₂, in FIG. 8B). In FIG. 8C, the variable focus lens 608 is controlled to lengthen the focal length of the optical system 602 relative to that shown in FIG. 8B. By way of example, the optical system 602 is focused at a point approximately 4.5 mm from the outer surface of the view window 612 (distance, d₃, in FIG. 8C). As can be appreciated from FIGS. 8A-8C, the optical system 602 can be focused across a relatively large working range that can, for example, span approximately 4 mm. Notably, even larger working ranges can be obtained through modification of the optical system 602, if desired. In addition, relatively high resolution images can be captured at any depth within that working range given that the optical system 602 is not designed for a large, fixed depth of focus. By way of example, lateral resolutions of approximately 1 micron (μm) to 10 μm can be achieved substantially at any depth within the working range.

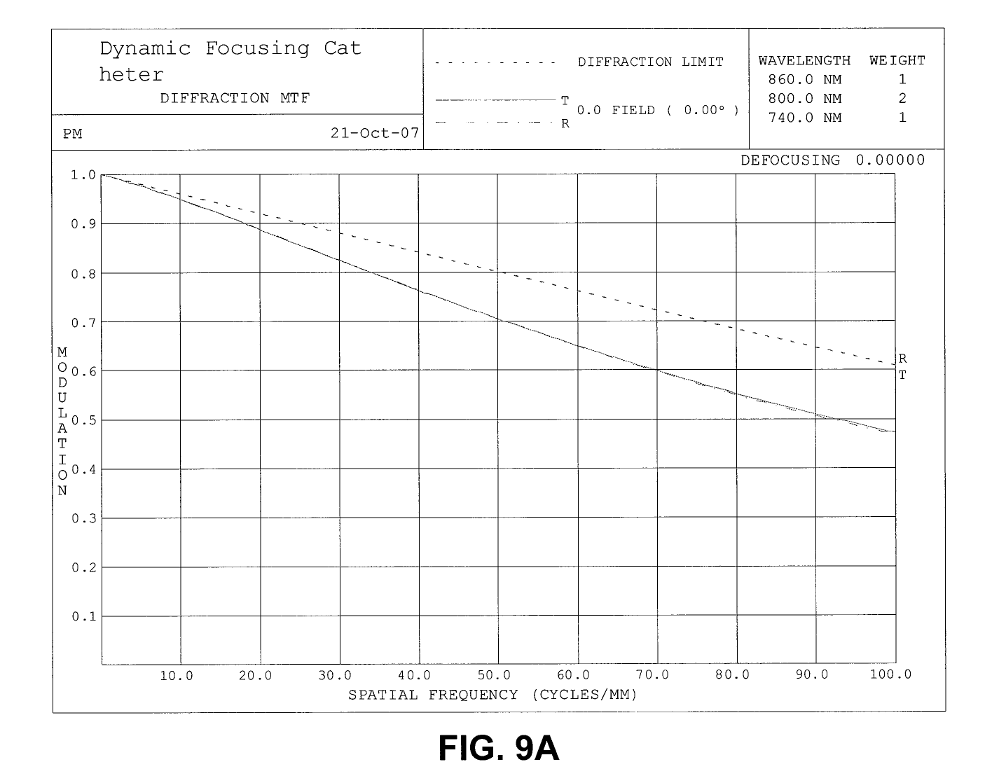

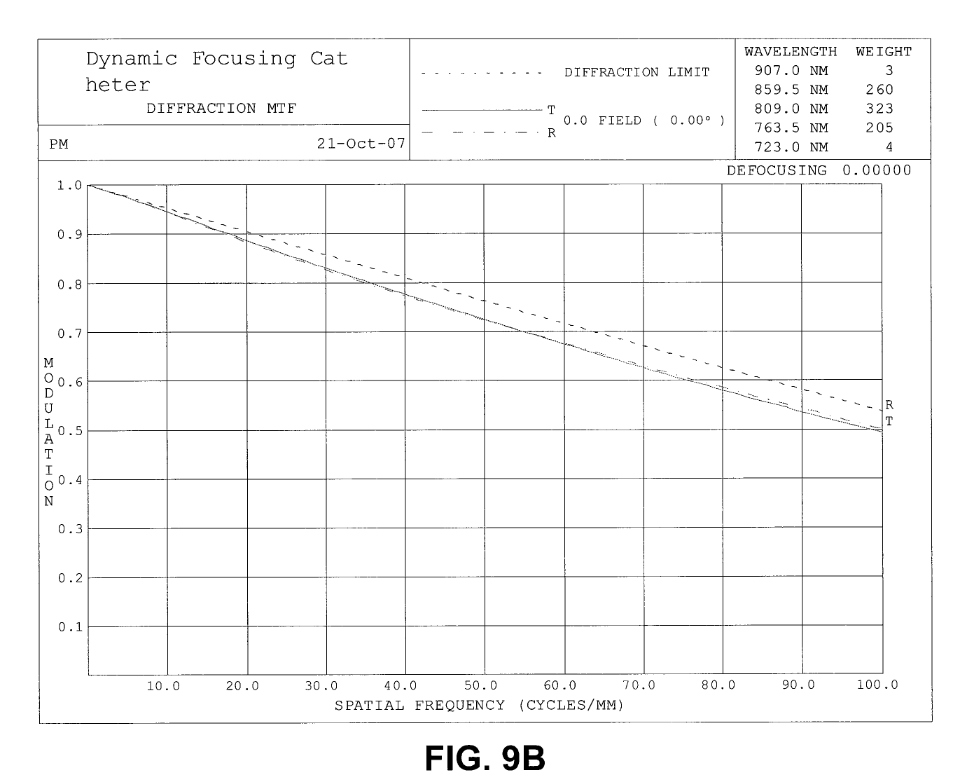

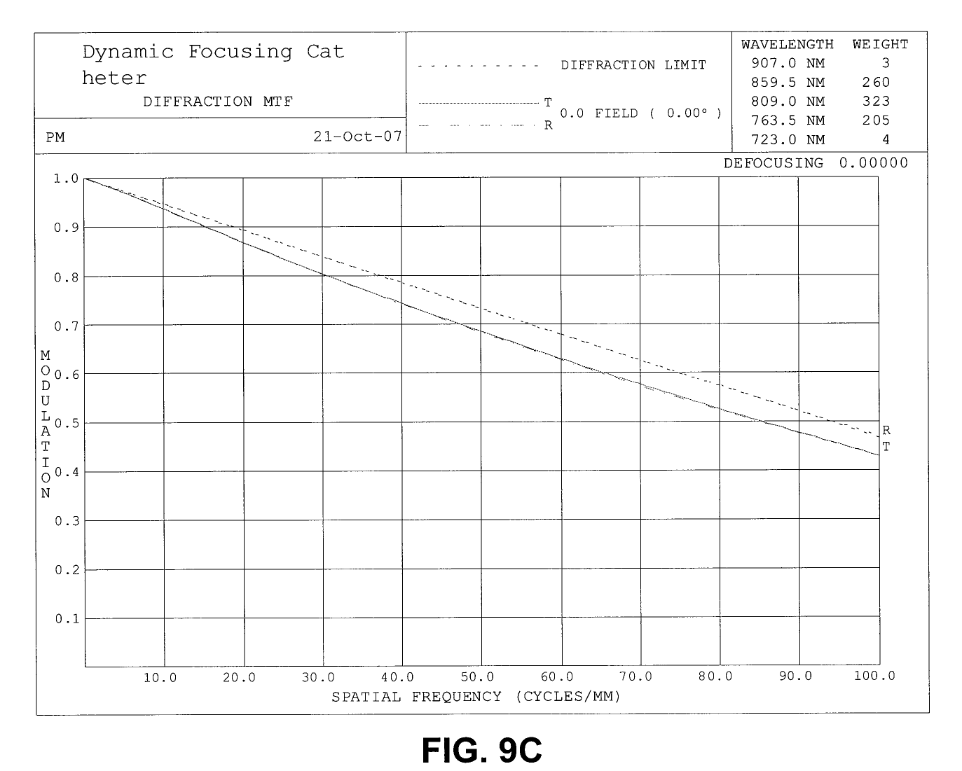

FIGS. 9A-9C are graphs of the modulation transfer functions (MTFs) for the focusing cases shown in FIGS. 8A-8C, respectively. Plotted in the graphs are the diffraction limits (dashed line) of the optical system 602 and frequency response curves of tangential (T) and sagittal (R) light rays achieved for the illustrated cases. As is apparent from FIGS. 9A-9C, an MTF of approximately 48% is achieved for the 0.5 mm case, an MTF of approximately 50% is achieved for the 2.4 mm case, and an MTF of approximately 42% is achieved for the 4.5 mm case.

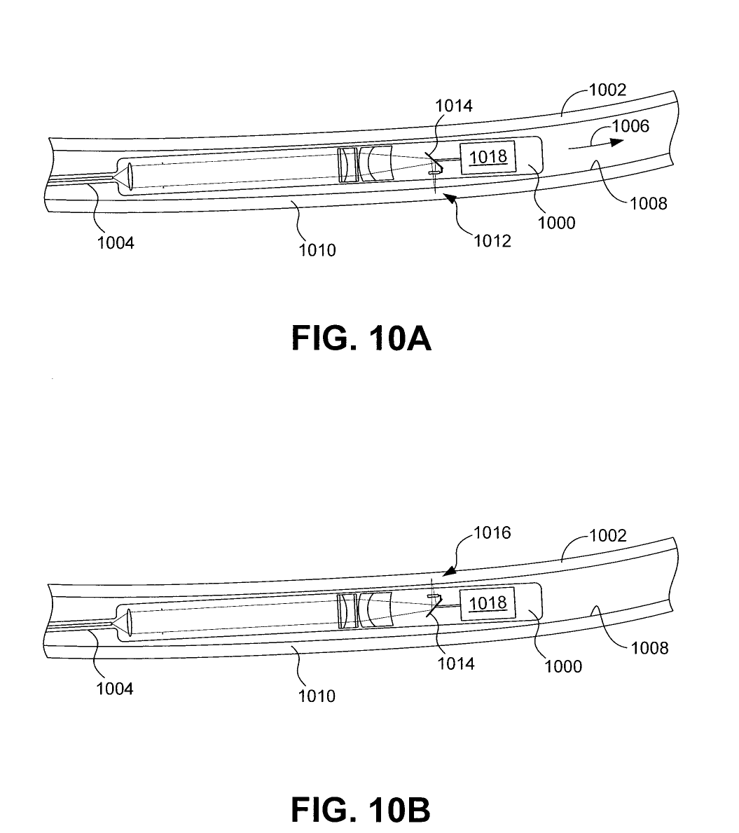

FIGS. 10A and 10B illustrate an optical probe 1000 in use within a vessel or lumen 1002. By way of example, the vessel or lumen 1002 comprises a human vessel, such as an artery or lung lobe. Referring first to FIG. 10A, the optical probe 1000 is shown positioned within the vessel or lumen 1002. For biological applications, the probe 1000 can have been positioned by introducing the probe into the vessel or lumen 1002 using a needle or trocar (not shown). Once so introduced, the probe 1000 can be placed into position along the vessel or lumen 1002 by advancing the probe using its cord 1004, for example in the direction indicated by arrow 1006. Optionally, appropriate external visualization techniques, such as x-ray imaging, can be used to guide in the practitioner positioning the probe 1000 at the desired imaging site.

Once the optical probe 1000 is positioned as desired, the inner surface 1008 and/or interior 1010 of the wall that forms the vessel or lumen 1002 can be imaged using the probe. In FIG. 10A, a first point 1012 within a bottom portion of the wall is imaged with the probe 1000.

Turning to FIG. 10B, a mirror 1014 of the probe 1000 has been rotated 180° relative to its position illustrated in FIG. 10A such that a second point 1016 of the wall is imaged. Although only two points of the wall have been illustrated as being imaged using the optical probe 1000, it is to be understood that the entire circumference of the vessel or lumen 1002 can be imaged in the same manner due to the 360° rotation capability of the mirror 1014. Therefore, in some embodiments, images may be continually captured as the mirror 1014 is continually or continuously rotated or “swept” by a micromotor 1018 of the probe 1000.

Various imaging technologies may be used to form images of the features of interest. In some embodiments, optical coherence tomography (OCT) optical coherence microscopy (OCM), or derivative techniques thereof, such as polarization sensitive OCT or OCM, can be used. OCT and OCM are non-contact, light-based imaging modalities that gather two-dimensional, cross-sectional imaging information from target tissues or materials. In medical and biological applications, OCT or OCM can be used to study tissues in vivo without having to excise the tissue from the patient or host organism. Since light can penetrate tissues to varying degrees, depending on the tissue type, it is possible to visualize internal microstructures without physically penetrating the outer, protective layers. OCT and OCM, like ultrasound, produces images from backscattered “echoes,” but uses infrared (IR) or near infrared (NIR) light, rather than sound, which is reflected from internal microstructures within biological tissues, specimens, or materials. While standard electronic techniques are adequate for processing ultrasonic echoes that travel at the speed of sound, interferometric techniques are used to extract the reflected optical signals from the infrared light used in OCT or OCM. The output, measured by an interferometer, is computer processed to produce high-resolution, real-time, cross-sectional, or three-dimensional images of the tissue. Thereby, OCT or OCM can provide in situ images of tissues at near histologic resolution.

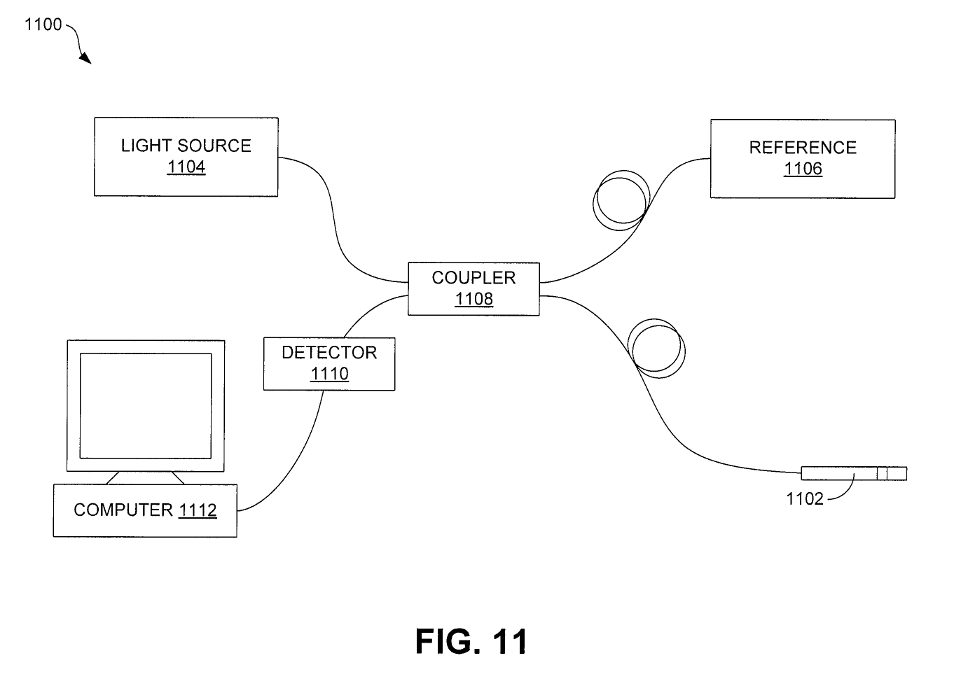

FIG. 11 illustrates an example system 1100 for performing OCT using an optical probe 1102. As indicated in that figure, the system 1100 comprises a light source 1104, such as a high-intensity, low coherence light source, that generates light to be transmitted to both the probe 1102 and a reference mirror 1106 via a coupler 1108, such as a beam splitter. The light signals received back from the probe 1102 and the reference mirror 1106 are then input into a detector 1110 that processes the interfered signals and outputs the results to a computer 1112.

For a detailed discussion of OCT as used in biological applications, refer to “Optical Coherence Tomography (OCT),” by Ulrich Gerckens et al., Herz, 2003, which is hereby incorporated by reference into the present disclosure. In embodiments in which OCT is used, IR or NIR light emitted from a high-intensity light source, such as a super-luminescent diode or a broadband laser, can be transmitted through the probe optical system. By way of example, a Gaussian beam having a central wavelength of approximately 800 nanometers (nm) to 1500 nm can be used. Notably, video rates can be achieved in cases in which Fourier-domain OCT or swept source OCT is performed.

As noted above, while particular embodiments have been described in this disclosure, alternative embodiments are possible. For example, alternative embodiments may combine features of the discrete embodiments described in the foregoing. In addition, although OCT and OCM have been specifically identified as example imaging technologies, others may be used. For instance, any technology that operates on the principle of low coherence interferometric imaging can be used. Furthermore, any other optical scanning imaging technology using beam focusing to sample, such as optical spectroscopy of fluorescence microscopy, can be used. All alternative embodiments are intended to be covered by the present disclosure.

We claim:

1. An optical probe comprising:
a housing configured for insertion into a lumen; and
an optical system provided within the housing, the optical system having a dynamically adjustable focal length such that the optical system can be focused at different points spaced a variety of distances from the housing while the probe is within the lumen.

2. The probe of claim 1 wherein the housing is generally cylindrical.

3. The probe of claim 2, wherein the housing is approximately 1 millimeter to 5 millimeters in diameter.

4. The probe of claim 1, wherein the housing includes a view window through which light transmitted along the probe can exit the probe and reflected light can enter the probe.

5. The probe of claim 4, wherein the view window surrounds a circumference of the housing.

6. The probe of claim 1, wherein at least a portion of the optical system is axially rotatable about a central axis of the probe to enable imaging through 360° relative to the central axis.

7. The probe of claim 6, wherein a fold mirror that reflects light out from the probe is axially rotatable about the central axis.

8. The probe of claim 7, further comprising a micromotor provided within the housing that rotates the at least a portion of the optical system.

9. The probe of claim 1, wherein the optical system comprises a focusing system that includes a variable focus lens that includes no moving mechanical components.

10. The probe of claim 9, wherein the variable focus lens comprises a liquid lens.

11. The probe of claim 9, wherein the variable focus lens comprises a liquid crystal lens.

12. The probe of claim 1, wherein the optical system can be dynamically adjusted to focus at points ranging from approximately 0.5 millimeters to approximately 4.5 millimeters from the housing.

13. The probe of claim 1, wherein the optical system has a lateral resolution of approximately 1 to approximately 10 microns.

14. An optical probe comprising:
a generally cylindrical housing configured for insertion into a lumen, the housing including a view window that surrounds a circumference of the housing; and
an optical system provided within the housing, the optical system comprising a focusing system and a fold mirror wherein the focusing system includes a variable focus lens that can be dynamically adjusted to change points at which the optical system focuses,
a shaft provided within the housing that supports the fold mirror; and
a micromotor provided within the housing that drives the shaft to rotate the fold mirror such that light focused by the focusing system can be reflected by the fold mirror out from the probe through the imaging lens and the view window in a variety of different radial directions.

15. The probe of claim 14, wherein the housing is approximately 1 millimeter to 5 millimeters in diameter.

16. The probe of claim 14, wherein the variable focus lens is a liquid lens.

17. The probe of claim 14, wherein the variable focus lens is a liquid crystal lens.

18. An optical probe comprising:
a housing configured for insertion into a lumen;
a curved view window through which light transmitted along the probe can exit; and
an optical system provided within the housing, the optical system including a cylindrical lens that compensates for the curvature of the curved view window.

19. The probe of claim 18, wherein the housing is generally cylindrical.

20. The probe of claim 19, wherein the housing is approximately 1 millimeter to 2 millimeters in diameter.

21. The probe of claim 18, wherein the view window surrounds a circumference of the housing.

22. The probe of claim 18, wherein the cylindrical lens is axially rotatable about a longitudinal central axis of the probe.

23. The probe of claim 22, further comprising a micromotor provided within the housing that rotates the cylindrical lens.
